(19) United States
(12) Patent Application Publication
(10) Pub. No.: US 2007/0276962 A1
(43) Pub. Date: Nov. 29, 2007

(54) File Synchronisation

(75) Inventor: Mark La Pensee, Guildford (GB)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/583,824

(22) PCT Filed: Dec. 22, 2004
(86) PCT No.: PCT/IB04/04252

§ 371 Date: Jul. 26, 2007

(30) Foreign Application Priority Data
Dec. 24, 2003 (GB) 0330051.4

(51) Int. Cl. G06F 15/16

(52) U.S. Cl. 709/248

(57) ABSTRACT

A method for synchronising data between a client device and a server device, at least one of the client device and the server device having synchronisation means, the method comprising: defining a first folder in a memory of the client device; defining a second folder in a memory of the server device; storing in the first folder data items of a certain type to be synchronised from the client device; storing in the second folder data items of the same type to be synchronised from the server device; and associating with each data item stored in the first and second folders an identifier for identifying the item; the client device and the server device being arranged such that a user of the devices cannot create subfolders within the first or second folders; and the synchronisation means being adapted to synchronise data items in the first and second folders on connection of the client device to the server device.

### FIELD OF THE INVENTION

The present invention relates to the transfer and synchronisation of data between electronic devices, and particularly to client and server devices.

### BACKGROUND OF THE INVENTION

In the general field of personal information management (PIM) it is commonly desirable to enter data into an electronic device, which might be a personal computer (PC), a mobile communications handset or a personal digital assistant (PDA), and subsequently to transfer the entered data from that device to another device with which the first device can be electrically connected. As a simple example, a user might wish to add a telephone number to the memory of a mobile telephone and to assign a name to that number. The user might then wish to update a phone book stored in the memory of his PC in order to update the PC phone book to include the new phone number data.

Currently used protocols for carrying out such synchronisation include SyncML. SyncML can be used to synchronise PIM data between a client device and a server device. Currently, only certain types of data stored in the client device or the server device can be synchronised. These types include contact data, calendar data and general notes. With SyncML, when a client device is connected to a server device, synchronisation will automatically take place to update the client device with any contact, calendar or notes data that has been entered into the server device since the most recent synchronisation, and correspondingly to update the server device with such data as has been added to the client device's memory since the last synchronisation.

According to the SyncML protocol, data to be synchronised must be stored within specific folders outside of the general file systems of the devices in which the data is stored. Thus, there will typically be a contacts folder, a calendar folder and a notes folder for storing data in a client device, and corresponding folders in a server device. Other types of data such as Word files, Excel files or picture files will be stored in a file system separately from the contacts, calendar and notes folders. This other data cannot be synchronised according to the SyncML protocol. The reason for this is that file systems do not necessarily incorporate mechanisms whereby every file and every folder can be identified uniquely within a device's memory for the entire lifetime of the device. Therefore, it is not possible to accurately determine whether a given folder in a file system has been added, amended or deleted since a previous synchronisation.

Known identifiers that are typically used in current file systems and/or databases include locally unique identifiers (LUIDs) and globally unique identifiers (GUIDs). An LUID is unique within a client device for a particular data store. LUIDs do not exist in file systems, only in databases.

A GUID is an identifier that is unique within a server device for a particular data store.

By the use of LUIDs and GUIDs in combination, a server device can determine correspondence between data items stored on a client device and those stored on the server device, and the server device can establish whether any of the data items have changed, or been added or deleted, since the last synchronisation.

Hierarchical file systems have the drawback of not being able to track when a folder has been re-named. SyncML, for example, has three commands: an add, a replace and a delete. None of these is capable of tracking a name change because when a folder is re-named, this change will be treated by SyncML as a delete of the original folder followed by an add of the newly named folder.

One way of overcoming this drawback would be to change the name of the root folder in which the folder is stored. However, this would be extremely inefficient because it would result in the transfer of all data stored in all folders within the root folder from one device to another when synchronisation takes place.

It is desirable to provide a method for synchronising data between devices which does not have the limitations of currently known file systems.

### SUMMARY OF THE INVENTION

In accordance with a first aspect of the present invention there is provided a method for synchronising data between a client device and a server device, at least one of the client device and the server device having synchronisation means, the method comprising: defining a first folder in a memory of the client device; defining a second folder in a memory of the server device; storing in the first folder data items of a certain type to be synchronised from the client device; storing in the second folder data items of the same type to be synchronised from the server device; and associating with each data item stored in the first and second folders an identifier for identifying the item; the client device and the server device being arranged such that a user of the devices cannot create subfolders within the first or second folders; and the synchronisation means being adapted to synchronise data items in the first and second folders on connection of the client device to the server device.

The first and second folders are preferably parts of file systems within the client device and the server device respectively, and the file systems may be such that any type of data can be stored in such a way that it can be synchronised on connection of the client device to the server device.

Each data item identifier is preferably unique within the client and server devices. A data item stored in the first folder or the second folder may be associated with a corresponding data item stored in the second folder or the first folder respectively by means of the identifier of the data item.

In accordance with a second aspect of the present invention there is provided a device for storing data, the device comprising a memory having a first folder, wherein: the first folder comprises data items of a certain type to be synchronised with a remote device, each data item having an associated identifier for identifying the item; the device is adapted to prevent a user from creating subfolders within the first folder; and synchronisation means within the device or the remote device are adapted to synchronise data items in the first folder with the remote device on connection of the device to the remote device.

The synchronising means may be adapted to synchronise data items in the first folder with corresponding data items stored in a second folder in the memory of the remote device.

Preferably, the first folder is a part of a file system within the device, and the file system may be such that any type of data can be stored in such a way that it can be synchronised with the remote device on connection of the device to the remote device.

Each data item identifier is preferably unique within the device, and a data item stored within the first folder may be associated with a corresponding data item stored in the remote device by means of the identifier of the data item.

In accordance with a third aspect of the present invention there is provided a system comprising: a client device comprising a memory having a first folder, the first folder comprising data items of a certain type to be synchronised from the client device; a server device comprising a memory having a second folder, the second folder comprising data items of the same type to be synchronised from the server device; and synchronisation means within at least one of the client device and the server device; wherein each data item in the first and second folders is associated with an identifier for identifying the data item; the client device and the server device are adapted to prevent a user of the devices from creating subfolders within the first or second folders; and the synchronisation means are adapted to synchronise data items in the first and second folders on connection of the client device to the server device.

### BRIEF DESCRIPTION OF THE DRAWINGS

The invention will now be described by way of example with reference to the accompanying drawings, in which:

FIG. 1 shows the schematic representation of a file system of an embodiment of the present invention.

### DETAILED DESCRIPTION

Embodiments of the present invention provide a file system in which one folder is allocated for every different type of data content. The folder will be allocated a name and a path. The name and path are not editable by a user. In addition, it will not be possible for a user to create child folders from these folders. The only operations which are available to a user are adding, deleting and modifying individual files within these folders.

A convenient term for these folders is “shared folders”. Since a folder is allocated for each type of content, a file system will typically contain, for example, a shared folder for photos, a shared folder for ring tones and so on.

By default, a shared folder will initially be empty, and will remain empty until a user stores information as a file within that shared folder. Each shared folder will in essence act as a mini database for a particular data type. To do so, it may contain data of that type either directly—by virtue of that data being stored in that folder—or indirectly—by storing or being associated with a link, a tag or a shortcut to that data, the data itself being stored in another folder.

When a file is added to a shared folder, the file will be allocated an LUID. Saving a new file within a shared folder, or copying a file from another folder to a shared folder, will be treated as an add command. If a file is subsequently deleted from a shared folder or moved from a shared folder to another folder the file will be treated as deleted. If a file is edited by a user, this will be treated as a replace command.

If a user wishes to synchronise a particular file, this may be achieved either by “tagging” that file as “syncable”, or by copying the file to a shared folder for the appropriate data type. Either of these actions will be treated as an add command. Once copied into the shared folder, the file will be allocated an LUID.

A file can be excluded from synchronisation either by deleting the file altogether from a client device or a server device, or by “untagging” it, or alternatively by moving the file into a different folder which is not a shared folder and therefore not syncable.

Preferably, an LUID value will only be used once per shared folder in the lifetime of a client device. A convenient length for the LUIDs is 32 bits, making approximately four billion values available.

Embodiments of the present invention can be applied to currently existing data stores, since the invention may be implemented in the hardware and/or software that controls writing to the datastore. Thus, in the case of a mobile telephone handset, for example, the hardware and/or software of the handset may be arranged so that a user of the handset may only make changes of certain types to data stored in folders that are to be synchronised with another device. The hardware and/or software may also enforce that the user may only store data files of one or more pre-determined types in each folder. Whether a data file is of a certain type may be determined from a part of the file name (for example an initial or final part of the file name such as the file specifier used in common operating systems) or from the content of the file (for example a file header that indicates the type of the data stored in the file).

A user's modification of folder names and folder paths can be restricted by the appropriate design of a user interface of a client device and/or a server device.

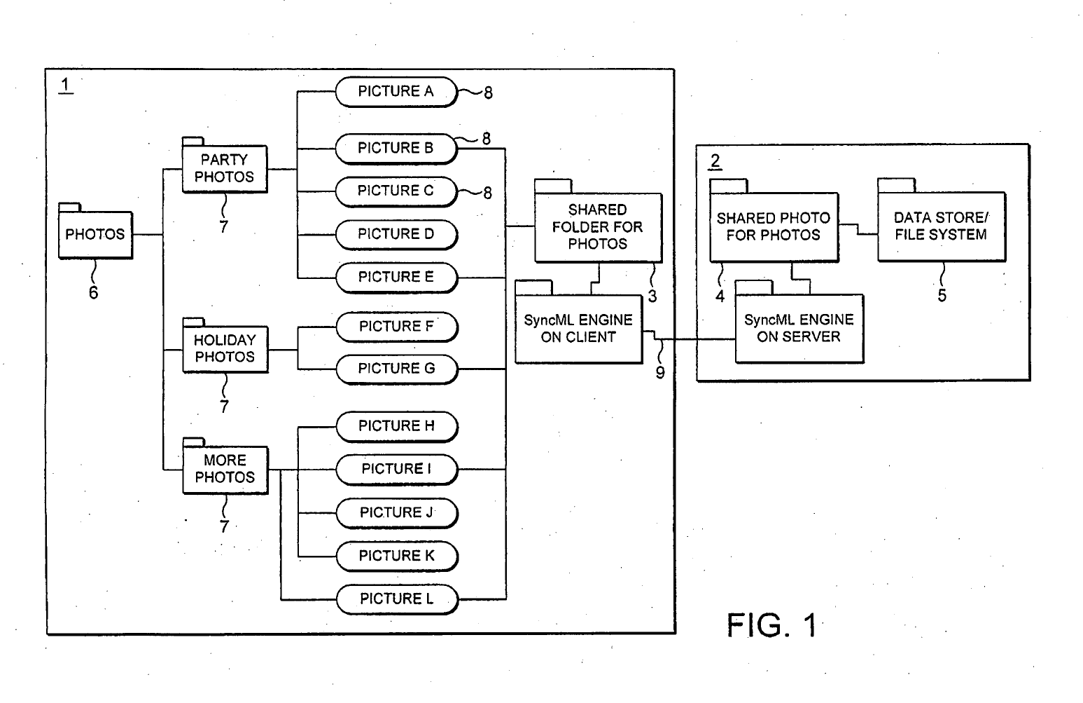

FIG. 1 shows a schematic representation of a client device and a server device in accordance with an embodiment of the present invention. The client device 1 is connected to the server device 2 by link 9.

Within the client device's memory is a file system, shown generally within 1. A root “photos” folder is shown at 6, and three child folders within the root folder are shown at 7—“party photos”, “holiday photos” and “more photos”. Each of the subfolders 7 contains photo data items 8 which may each represent a single photograph.

A shared folder for photos is shown at 3, and links can be seen from pictures b, e, g, i and I to the shared folder. These links denote that a user of the client device 1 has indicated to the device that those photos should be “syncable”. This means that the data items corresponding to pictures b, e, g, i and I have either been copied into the shared folder 3 or have been tagged as syncable within the general file system. On connection of the client device to the server device, any changes that may have been made to these photos and saved to the memory of one of the devices will be synchronised to the other device.

In some embodiments, the shared folder 3, and the shared folder 4 within the server device, may contain files that are not also saved in the general memory of the client device (6, 7) or the server device (5). These files will be synchronised when the client device is connected to the server device.

1. A method for synchronising data between a client device and a server device, at least one of the client device and the server device having synchronisation means, the method comprising:
defining a first folder in a memory of the client device;
defining a second folder in a memory of the server device;
storing in the first folder data items of a certain type to be synchronised from the client device;
storing in the second folder data items of the same type to be synchronised from the server device; and
associating with each data item stored in the first and second folders an identifier for identifying the item;
the client device and the server device being arranged such that a user of the devices cannot create subfolders within the first or second folders; and
the synchronisation means being adapted to synchronise data items in the first and second folders on connection of the client device to the server device.

2. A method as claimed in claim 1 wherein the first and second folders are respectively parts of file systems within the client device and the server device and the file systems are such that any type of data can be stored in such a way that it can be synchronised on connection of the client device to the server device.

3. A method as claimed in claim 1 or claim 2 wherein each data item identifier is unique within the client and server devices.

4. A method as claimed in any preceding claim wherein a data item stored in the first folder or the second folder is associated with a corresponding data item stored in the second folder or the first folder respectively by means of the identifier of the data item.

5. A device for storing data, the device comprising a memory having a first folder, wherein:
the first folder comprises data items of a certain type to be synchronised with a remote device, each data item having an associated identifier for identifying the item;
the device is adapted to prevent a user from creating subfolders within the first folder; and
synchronisation means within the device or the remote device are adapted to synchronise data items in the first folder with the remote device on connection of the device to the remote device.

6. A device according to claim 5 wherein the synchronising means are adapted to synchronise data items in the first folder with corresponding data items stored in a second folder in the memory of the remote device.

7. A device according to claim 5 or claim 6 wherein the first folder is a part of a file system within the device and the file system is such that any type of data can be stored in such a way that it can be synchronised with the remote device on connection of the device to the remote device.

8. A device according to any of claims 5 to 7 wherein each data item identifier is unique within the device.

9. A device according to any of claims 5 to 8 wherein a data item stored within the first folder is associated with a corresponding data item stored in the remote device by means of the identifier of the data item.

10. A system comprising:
a client device comprising a memory having a first folder, the first folder comprising data items of a certain type to be synchronised from the client device;
a server device comprising a memory having a second folder, the second folder comprising data items of the same type to be synchronised from the server device; and
synchronisation means within at least one of the client device and the server device; wherein
each data item in the first and second folders is associated with an identifier for identifying the data item;
the client device and the server device are adapted to prevent a user of the devices from creating subfolders within the first or second folders; and
the synchronisation means are adapted to synchronise data items in the first and second folders on connection of the client device to the server device.

11. A system according to claim 10 wherein the first and second folders are respectively parts of file systems within the client device and the server device and the file systems are such that any type of data can be stored in such a way that it can be synchronised on connection of the client device to the server device.

12. A system according to claim 10 or claim 11 wherein each data item identifier is unique within the client and server devices.

13. A system according to any of claims 10 to 12 wherein a data item stored in the first folder or the second folder is associated with a corresponding data item stored in the second folder or the first folder respectively by means of the identifier of the data item.
